(19) United States
(12) Patent Application Publication
(10) Pub. No.: US 2020/0274851 A1
(43) Pub. Date: Aug. 27, 2020

(54) FULL FEATURED PACKET-BASED AUTOMOTIVE NETWORK SECURITY GATEWAY

(71) Applicant: Juniper Networks, Inc., Sunnyvale, CA (US)

(72) Inventors: Ming Qiao, Ottawa (CA); Jan Smith, Stittsville (CA)

(21) Appl. No.: 16/725,522

(22) Filed: Dec. 23, 2019

Related U.S. Application Data
(60) Provisional application No. 62/809,272, filed on Feb. 22, 2019.

(51) Int. Cl. H04L 29/06; G06F 9/455; G06F 8/65; B60R 16/023; H04L 12/40

(52) U.S. Cl. CPC H04L 63/0245; H04L 63/1416; H04L 63/145; H04L 63/0263; G06F 9/45541; G06F 9/45558; H04L 2012/40234; B60R 16/0231; H04L 12/40; G06F 2009/45587; H04L 2012/40273; H04L 2012/40215; G06F 8/65

(57) ABSTRACT

In some examples, an automobile comprises a plurality of electrical components interconnected by a communication network. The automobile comprises a set of policies that logically partition the electrical components of the automobile into a first zone having one or more of the critical components and a second zone having one or more of the non-critical components, the policies specifying rules for communication between the zones defined for the communication network within the automobile. The automobile further comprises a security gateway embedded within the automobile and coupled, by the communication network, to the one or more critical components and the one or more non-critical components. The security gateway is configured to provide security operations by applying the policies to communications within the automobile to determine, based on the rules defined by the policies, whether to forward or drop data packets communicated on the communication network.

This application claims the benefit of U.S. Provisional Patent Application No. 62/809,272, filed Feb. 22, 2019, the entire content being incorporated herein by reference.

### TECHNICAL FIELD

The invention relates to automotive electronics, and, more particularly, to internal electronic communication devices for automobiles.

### BACKGROUND

Newer automobiles include a multitude of internal electronic devices such as Bluetooth modules, cellular transceivers, electronic sensors and gauges, electronic control systems, electronic monitoring and safety mechanisms, infotainment systems and the like. Newer automobiles also include advanced electronic systems, such as autonomous vehicle systems, advanced navigation and motor/engine control systems, and driver-assistance systems.

In general, the various electronic systems within an automobile often communicate using internal, proprietary protocols, as well as industry standards such as a Controller Area Network (CAN) bus or a Local Interconnect Network (LIN) bus. In addition, electronic systems within the automobile can communicate wirelessly using Wi-Fi or Bluetooth technology.

The electronic devices of an automobile may be connected to local devices in the automobile as well as to external networks through the cellular transceiver or a Wi-Fi module (e.g., for communicating in a garage or at a charging station). The electronic devices in the automobile can periodically receive software updates from a legitimate software developer. However, an attacker can attempt to gain control over the critical systems of an automobile by communicating with the electronic devices in the car through the cellular transceiver, the Wi-Fi module, or another non-critical component. The attacker may also attempt to gain control over the critical systems via a local device that is in communication with a Bluetooth module, a Wi-Fi module, or a USB port of the automobile.

Some automobiles cannot prevent such an attack on the critical systems of the automobile. Other automobiles prevent an attack by “air-gapping” the electronic devices and systems: each electronic device and system of the automobile is not communicatively coupled to the other devices and systems of the automobile. The systems can be air-gapped by having a separate processor and a separate memory for each system. An air-gap solution can prevent an attack from the internet or from a local device because the critical systems are not interconnected with the other components in the automobile. However, an air-gap solution restricts the flexibility and functionality of the electronic devices within the automobile.

### SUMMARY

In general, this disclosure describes example architectures for an advanced, packet-based network security gateway device having a configuration, reduced computational resource requirements and overall form factor such that the gateway can easily be embedded within an automobile yet still provide rich, full-featured security and intrusions detection and prevention (IDP). For example, a packet-based communication infrastructure is configured within the automobile, and the low-power network security gateway device network security gateway device described herein can be configured to partition the internal electronic components of the automobile into two or more logical zones and to apply zone-based firewall policies to apply rules to packets flowing throughout internal communication network of the automobile. Moreover, the network security gateway device may be configured as an advanced next generation firewall that uses deep packet inspection techniques, such as intrusion detection and prevention, at various layers of the network stack, including layer two (L2)-layer (L7), including application-layer packet inspection.

In this way, the security gateway enables application of rich security features and policies for secure communication among the internal components of the automotive system, as well as communication with external networks. Thus, communication functionality that may be required for automotive operation and control is maintained or increased without sacrificing security. For example, typical network rack-scale firewalls and security appliances may be unworkable in an automotive context for size, weight, power, cost and other reasons such as interface requirements. However, the example network security gateway devices described herein can implement a feature-rich firewall on a microprocessor that is smaller, lighter, and less expensive than the processing systems inside a rack-scale networking device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example network security gateway device in an automobile system as described herein.

FIG. 2 is a block diagram illustrating an example security gateway running a software-based firewall in accordance with the current disclosure.

FIG. 3 is a chart illustrating an example configuration of a firewall for providing zone-based firewall services in accordance with the current disclosure.

FIG. 4 is a block diagram illustrating security gateways in multiple automobiles connected to an example public network in accordance with the current disclosure.

FIG. 5 is a block diagram illustrating a network security gateway device with a firewall running in a container on a hypervisor.

FIG. 6 is a block diagram illustrating a firewall running as a native application on an operating system.

FIG. 7 is a block diagram illustrating in further detail a network security gateway device running a containerized firewall.

FIG. 8 is a flowchart showing an example operation of a network security gateway device.

### DETAILED DESCRIPTION

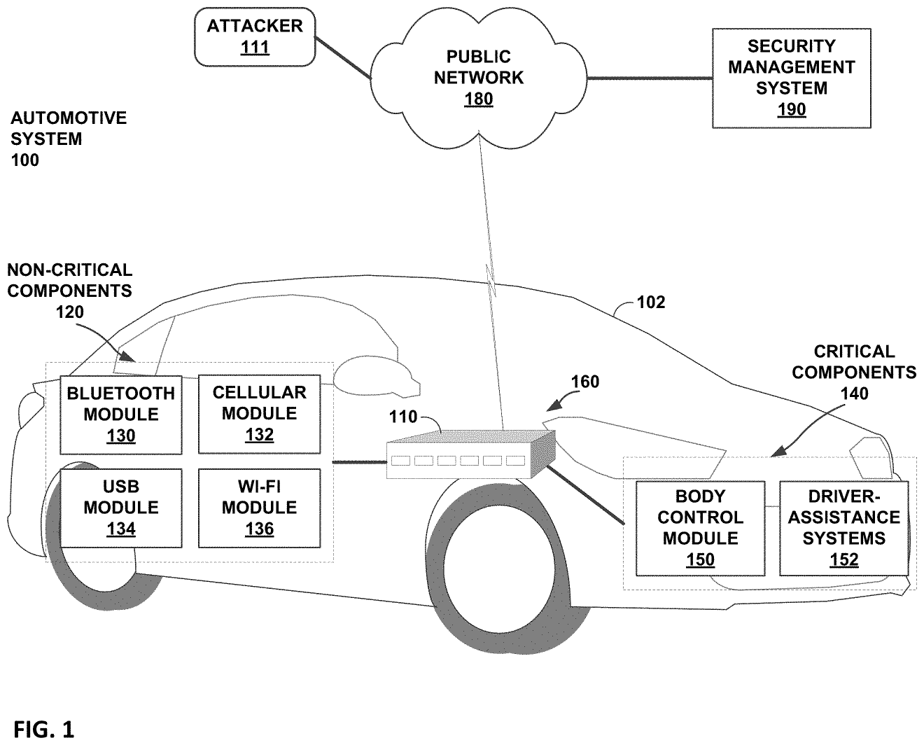

FIG. 1 is a block diagram illustrating an example network security gateway device in an automobile system 100 as described herein. In this example, automotive system 100 includes automobile 102, network security gateway device 110, and a plurality of internal electrical components grouped as non-critical components 120 and critical components 140 interconnected by, in this example, communication network 160. Although represented as a car, automobile 102 may be a different other land vehicle such as a car, truck, utility vehicle, bus, motorcycle, or train. Automobile 102 may be an electric vehicle and/or a vehicle with an internal combustion engine.

As further described herein, network security gateway device 110 may be architected and configured, including having reduced computational resource requirements and overall form factor such that the gateway can easily be embedded within an automobile yet still provide rich, full-featured security and intrusions detection and prevention (IDP). For example, network security gateway device 102 can be configured to logically partition the internal electronic components of the automobile into two or more logical communication zones and to apply zone-based firewall policies to apply rules to packets flowing throughout internal communication network of the automobile, which may be a packet-based communication network 160. Moreover, the network security gateway device may be configured as an advanced next generation firewall that uses deep packet inspection techniques, such as intrusion detection and prevention, at various layers of the network stack, including layer two (L2)-layer (L7), including application-layer packet inspection.

As a full-featured security device, network security gateway device 110 applies and enforces policies to internal communications flowing between “zones” representing logical partitions between the internal electrical components, systems and devices of automotive system 102. In the example of FIG. 1, the electrical components, systems and devices have been logically partitioned into two zones, depicted as non-critical components 120 and critical components 140. Additional and/or different zones and traffic forwarding rules and policies may be easily defined, e.g., by a manufacturer of automobile 102.

In this example, non-critical components 120 are internal electronic components, devices and systems of automobile 102 that, in general, do not directly control the operation of automobile 102 or affect the safety of the occupants of automobile 102. As examples, non-critical components 120 may include user-facing electronic devices that do not relate to driving such as entertainment systems, infotainment systems, an audio system, speakers, displays (e.g., heads-up displays), user interfaces, internet browsing, navigation, and so on. Bluetooth module 130, USB module 134, and Wi-Fi module 136 allow a mobile device such as a phone, tablet, or laptop to connect to the components of automotive system 100.

Critical components 140 are the internal electronic components, devices and systems that relate to and directly affect the operation of automobile 102 and/or the safety of the occupants. Critical components 140 include autonomous vehicle systems, motor/engine control systems, and driver-assistance systems. For example, body control module 150 coordinates the operation of the windows, mirrors, locks, doors, headlights, anti-theft protection, air conditioning, and other components of automobile 102. Driver-assistance system 152 can include adaptive cruise control, lane centering, collision avoidance, and blind spot systems. Critical components 140 also include electronic devices relating to the braking, turning, powering on, and powering off automobile 102, as well as fuel systems, wheel and tire sensors, exhaust sensors, and anything relating to the operation of an engine or motor.

Any of the modules of automobile 102, including the components of non-critical components 120 and critical components 140, can receive software or firmware updates from security management system 190 via public network 180. For example, Bluetooth module 130 and/or cellular module 132 (e.g., Long-Term Evolution (LTE)) may receive a software or firmware update from security management system 190 or another source via public network 180. Network security gateway device 110 can perform intrusion detection and prevention on the updated received by the modules of automobile 102 to detect and drop any communications from malicious entities.

Network security gateway device 110 can apply policies and firewall rules to east-west traffic (e.g., traffic between non-critical components 120 and critical components 140) and to north-south traffic (e.g., traffic between public network 180 and any of the components of automotive system 100). Security management system 190 may provide updates for the policies and/or firewall rules to network security gateway device 110. For example, security management system 190 can send an update to network security gateway device 110 that adds, deletes, or modifies the rules and policies stored in and applied by network security gateway device 110. Security management system 190 can also add new virus protections and/or threat and anomaly detection procedures to network security gateway device 110.

Security management system 190 can develop updates for network security gateway device 110 based on information received from network security gateway device 110. A user (e.g., an administrator) may use security management system 190 to define zones and corresponding security policies with respect to the physical interfaces within automotive system 100. For example, network security gateway device 110 can send reports and records to security management system 190, such as the policies and rules implemented by network security gateway device 110, the threats detected by network security gateway device 110, and the packets dropped by network security gateway device 110. Network security gateway device 110 can report this information to security management system 190 on a regular basis or in response to a request from security management system 190.

In some examples, security management system 190 has a birds-eye view of a fleet of automobiles and receives reports and records from network security gateway devices in each of the automobiles. Security management system 190 may be configured to analyze the information received from the fleet to detect vulnerabilities in the fleet. Security management system 190 can install policies that are developed based on network traffic patterns in automobile 102 or in other vehicles, or even in other non-vehicle networks. For example, security management system 190 can learn of a certain type of attack that has occurred elsewhere in the fleet and may send an update to network security gateway device 110 through public network 180 to protect against a similar attack.

Security management system 190 may also receive records from security devices outside of automotive applications, such as security devices in enterprise applications and data center applications. Security management system 190 can analyze all of the records received from security devices to create updates to the rules and policies stored on network security gateway device 110.

In this way, network security gateway device 110 provides rich security feature set to protect and secure communication network 160, which interconnects non-critical components 120 and critical components 140. As discussed, network security gateway device 110 allows communication network 160 to be logically partitioned into a plurality of zones, where each zone includes one or more components. For example, all of non-critical components 120 can be grouped into a first zone, and all of critical components 140 can be grouped into a second zone. In another example, non-critical components 120 can be divided into multiple zones. Further, public network 180 may be defined as a zone that is separate from the zones that cover non-critical components 120 and critical components 140, thereby allowing different forwarding policies to be defined and applied to traffic flowing between non-critical components 120 and public network 180 relative to traffic flowing between critical components 140 and public network 180. Network security gateway device 110 and/or security management system 190 may provide an interface that allows a user to define zones and corresponding security with respect to physical interfaces. Similarly, specific forwarding policies can be defined and applied to traffic flowing between non-critical components 120 and critical components 140 and public network 180.

In one example, the components of automotive system 100 communicate using communication network 160, which may be one or more interconnected communication systems internal to automobile 102. In one example, network security gateway device 110 receives and operates on packet-based data units, such as ethernet frames, traversing communication network 160. In another example, there may be an underlying communication infrastructure that translates and transforms an internal non-ethernet communication messaging format to ethernet packets such that the packets can be processed by network security gateway device 110. For example, data in communication network 160 can be communicated within automobile 102 using a Controller Area Network (CAN) bus, a Local Interconnect Network (LIN), a combination thereof, or the like.

Various examples of network security gateway device 110 provide intrusion detection and prevention to attacks by a would-be attacker 111. During a malicious hack, an attacker 111 attempts to control the operation of automobile 102 by gaining control of critical components 120. To gain control of critical components 120, the attacker may first gain control of non-critical components 140 and then communicate with critical components 120 using packets traveling on communication network 160. Without separation (e.g., a firewall) between the different zones of communication network 160, malicious packets can travel between non-critical components 120, critical components 140, and public network 180. The attacker may gain control of automotive system 100 to control the operation of automobile 102 or to steal information stored in automotive system 100.

In general, as recognized herein, network security gateway device 110 may provide full-featured, advanced security features otherwise not available in limited resource environments, such as automobile 102. Such features may be advantageous in modern vehicles where drivers and passengers increasingly desire more interaction between their mobile devices and the electronic components of automotive system 100, such as integrated, user-friendly functionality for streaming music or other content directly from a mobile device to the audio system of automobile 102. Similarly, passengers may want to browse the internet or otherwise access resources of public network 180 from the electronic devices of automotive system 100, and passengers expect that the components of automotive system 100 will have Internet access. Moreover, automotive manufacturers want to quickly and seamlessly deploy software updates to the components of automotive system 100, including critical components 140, to address performance issues and provide new functionality to users. Network security gateway device 110 allows rich, security features to be uniquely configured and applied to traffic to provide fine grain control over traffic forwarded

In accordance with various aspects of the techniques of this disclosure, network security gateway device 110 provides a centralized way to quickly control, manage, and deploy firewall rules and policies, including anti-virus and attack detection, for protecting the components of automotive system 100. In some examples, network security gateway device 110 can operate a software-defined firewall for scanning and inspecting packets. As a zone-based firewall, network security gateway device 110 provides, for example, separation and a layer of protection for east-west traffic and for north-south traffic. As such, network security gateway device 110 may provide deep-packet inspection to packets received from public network 180 traveling to automotive system 100 by scanning for abnormal information in the header or the payload of the packet, such as specific character strings, or by pattern matching symbols within the packets to virus or attack definitions. Network security gateway device 110 applies pattern recognition to identify and drop packets with malicious information.

In one example, as a zone-based firewall, network security gateway device 110 decides whether to drop or forward the packets traveling on communication network 160 by applying rules and policies. The rules and policies include zone-based rules based on the source and destination of each packet. Further, network security gateway device 110 may also include advanced intrusion detection and prevention (IDP), including application identification and deep packet inspection, to dynamically detect and protect against network and application-layer attacks.

In operation, for example, network security gateway device 110 can be configured to inspect and apply specific policies to east-west traffic, which as used herein is traffic internal to automobile 102. For example, an east-west packets can have a source of Bluetooth module 130 and a destination of an audio system within non-critical components 120. Another east-west packet can have a source of body control module 150 and a destination of one of non-critical components 120. Network security gateway device 110 can also operate on north-south traffic, which is used herein to refer to traffic between public network 180 and automotive system 100. For example, many of the components of automotive system 100 will communicate with public network 180 to, for example, receive software/firmware updates, navigation data, streaming content or route updates from resources reachable through public network. A cloud-based automotive control center (e.g., security management system 190) may, for example, provide updates to the components of automotive system 100 through public network 180, which can be scanned and provided securely through network security gateway device 110. In this way, network security gateway device 110 can allow electronic content (e.g., media, executables, firmware, etc.) received from various cloud-based resources through public network 180 to reach non-critical components 120 and critical components 140 after inspection and application of security policies.

In some examples, network security gateway device 110 can send network traffic information to security management system 190, including records of actual packets, identified threats, packets that are dropped due to application of current policies, raw traffic statistics, policies and rules enforced by network security gateway device 110, and/or numbers and types of packet flows between each component. Security management system 110 can analyze the received data, along with data received from other network devices, in the cloud to create and push new policies to network security gateway device 110.

Using network security gateway device 110 in automotive system 100 may be preferable to conventional techniques of physically isolating the components of automotive system 100 (e.g., “air-gapping”). Scanning traffic with network security gateway device 110, rather than air-gapping, allows communication between non-critical components 120, critical components 140, and public network 180 to provide more functionality for automotive system 100, such as internet access and interconnectedness.

As described herein, although operable in a resource-limited environment, network security gateway device 110 may be implemented in accordance with open architecture (e.g., not platform-specific) hardware and software. As one example, network security gateway device 110 can include hardware platform for executing a software-based firewall that runs as a virtual machine or container on a hypervisor of the device. The container-based firewall can run on the hypervisor, which runs on the operating system of network security gateway device 110. In other examples, the software-based firewall runs an application directly on the operating system of network security gateway device 110 without any containers. Running the software-based firewall directly on the hardware of network security gateway device 110 is referred to herein as a “bare-metal solution.”

Network security gateway device 110 may have a small footprint and small power consumption. A small footprint (form factor and weight) may be especially important for automotive system 100 because space is limited and extra mass can affect the efficiency of automobile 102. The power consumption of network security gateway device 110 also affects the efficiency of automobile 102 in examples in which network security gateway device 110 runs on the battery or alternator of automobile 102. Moreover, network security gateway device 110 may be much less expensive than a rack-scale security appliance running a firewall. Network security gateway device 110 provides a way to manage the security of automotive system 100 with scale, so that an automotive manufacturer can include network security gateway device 110 in thousands or millions of automobiles.

To keep cost and size low, network security gateway device 110 can include a reduced-instruction-set-computer (RISC) microprocessor, such as a microprocessor developed based on a design by Advanced RISC Machines (ARM) of Cambridge, England. Network security gateway device 110 may include a limited number of cores (e.g., processors), such as two, four, or eight cores, as compared to a rack-scale router, which may have twenty, thirty, or more cores. Even though resources may be extremely constrained, network security gateway device 110 can still provide next-generation security and firewall features using the techniques described herein.

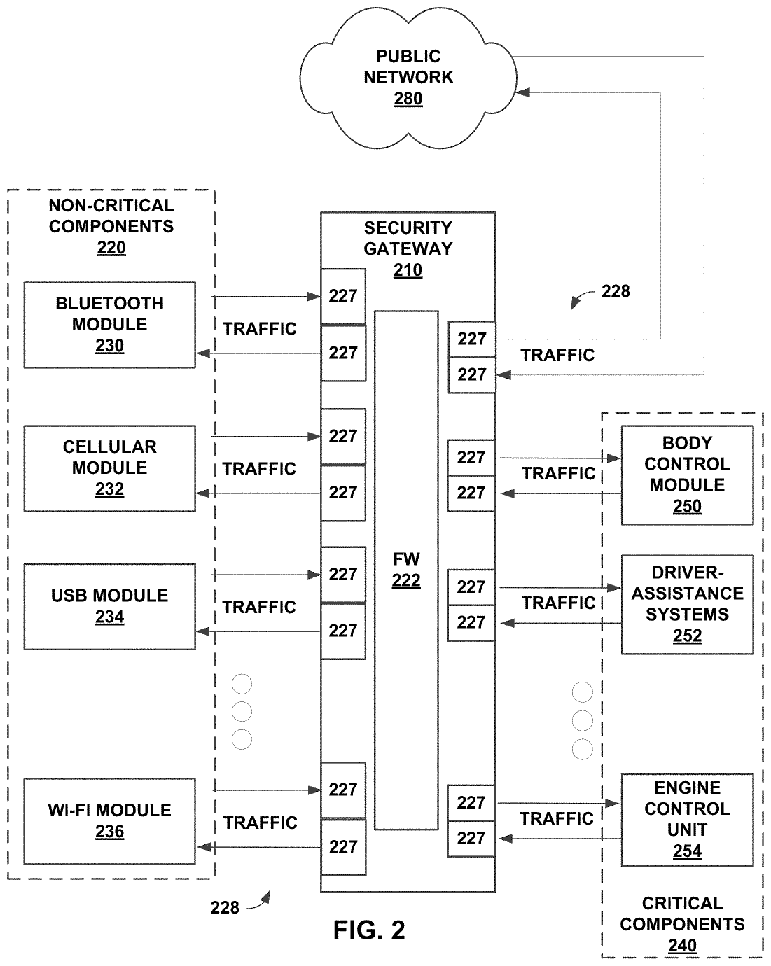

FIG. 2 is a block diagram illustrating an example security gateway 210 running a software-based firewall 222. Security gateway 210 is an example of network security gateway device 110 shown in FIG. 1, which can be installed in an automobile and operate to provide security features to communications within the automobile. In this example, security gateway 210 includes a plurality of physical interfaces 227 for sending and receiving traffic (communications) 228 between components 220, 240.

In the example shown in FIG. 2, firewall 222 provides zone-based firewall services that allow zone-based security policies to be defined and applied for the different network interfaces 227 of the gateway 210. In the example of FIG. 2, security gateway 210 includes physical interfaces 227 for sending and receiving traffic 228 to and from components 230, 232, 234, 236, 250, 252, and 254 via internal physical connections, which may be Ethernet cables, serial or parallel connections, proprietary communication busses, and the like. Security gateway 210 provides an interface, e.g., accessible via a security management system, that allows a user (e.g., an administrator associated with the manufacture of automobile 102 and/or security management system 190) to define zones and corresponding security policies with respect to those physical interfaces. Security gateway 210 can present network traffic data to the user, where the traffic data may include detected threats and packets dropped.

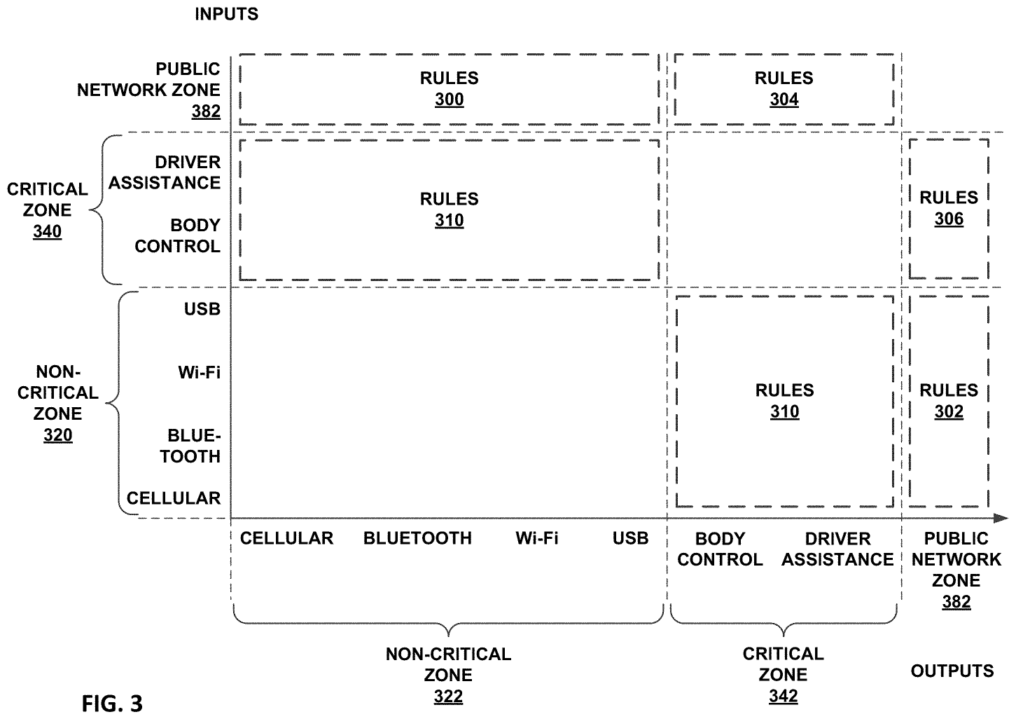

FIG. 3 is a chart illustrating an example configuration of firewall 222 of security gateway 210 for providing zone-based firewall services. In the chart of FIG. 3, the vertical axis represents all of the input interfaces of security gateway 210, including N physical input interfaces (any of interfaces 227 of FIG. 2 for input links). The horizontal axis represents all of the output interfaces of security gateway 210, including X physical output interfaces (any of interfaces 227 of FIG. 2 for output links). In this example, the administrator has interacted with the user interface of security gateway 210 to define the following distinct zones: (1) a first zone 320 for all traffic received from non-critical components 220, (2) a second zone 322 for all traffic output to non-critical components 220, (3) a third zone 340 for all traffic received from critical components 240, (4) a fourth zone 342 for all traffic output to critical components 240, (5) a fifth zone 380 for all traffic received from public network 280, (6) a sixth zone 382 for all traffic output to public network 280. Zones 320 and 322 may be referred to as “untrust,” zones 340 and 342 may be referred to as “trust,” zones 360 and 362 may be referred to as “public.” Network security gateway device 210 can treat each zone as a subnetwork on a local area network. In some examples, non-critical components 220 may be broken up into more than one zone, and critical components 240 may also be broken up into more than one zone.

The following rules and policies may be set at the time of manufacture of security gateway 210 or the at the time of manufacture of the automotive system. After that time, security rules and policies on security gateway 210 can be updated by transmitting over the air (e.g., cellular). In this example, security gateway 210 applies rules 300, 302, 304, 306, 310, and 312 as firewall rules, which may be applied to any of L2-L7 information (including application-layer information) assembled from packet flows traversing the internal communication network. According to rules 300 and 302, the traffic between non-critical zones 320 and 322 to public network zones 380 and 382 is permitted so that the users can access internet for traffic such as entertainment.

Rules 300 and 302 may provide that user devices in non-critical zone 320 are able to browse the web or use a navigation or mapping application but not able to access a video streaming service. For example, rules 300 and 302 may allow or block Hypertext Transfer Protocol (HTTP) or HTTP Secure (HTTPS) packets. Rules 300 and 302 can also include web filtering to provide fine-grained control of the web addresses that users can or cannot access when a user device is connected to the automotive system. Rules 300 and 302 are configurable to define that some specific web addresses may be allowed while other web addresses are not allowed, and some categories of web addresses are allowed while other web addresses are not allowed.

According to rules 304 and 306, the critical zones 340 and 342 are isolated from public network zones 380 and 382. According to rules 310 and 312, security gateway 210 can ensure no access between the non-critical zones and the critical zones, except some specific channels for traffic like management. In some configurations, security gateway 210 does not allow traffic between the non-critical zones and the critical zones, except that one particular device in non-critical zone 320 can access an internal server in critical zone.

Security gateway 210 may also be configured to perform IDP on packets so as to protect against network and application attacks. For example, a hacker may attempt to gain access to one of non-critical components 220 locally or remotely to attack critical components 240. Security gateway 210 can prevent all types of attacks and react based on predefined rules. Responsive to detecting a threat, security gateway 210 can block traffic from the same sender for a period of time. Security gateway 210 can set a flag to indicate an alert and output an indication of the alert to a monitoring system via public network 280. Security gateway 210 can protect against malformed packets, port scans, flooding, denial of service attacks, and distributed denial of service attacks.

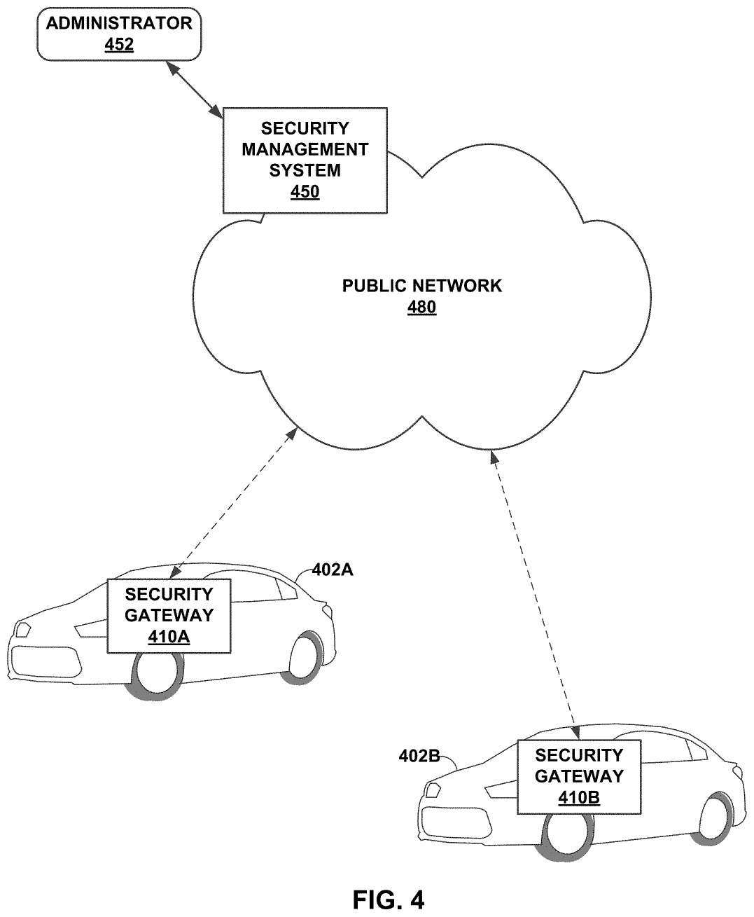

FIG. 4 is a block diagram illustrating security gateways 410A and 410B in multiple automobiles 402A and 402B connected to an example public network 480 and managed by a central, cloud-based security management system 450 in accordance with the current disclosure. Each of security gateways 410A and 410B may be a standalone device (such as security gateway device 110, 210) embedded within an automobile and performing firewall and networking functions.

As such, security gateways 410A and 410B monitor packet flows to and from public network 480 and apply security services to those packet flows so as to protect the components of each respective automobiles 402A and 402B. For example, security gateways 410A and 410B may perform deep packet inspection on the packet flows to detect patterns or anomalies within the packet flows that are indicative of threats, such as network attacks, viruses, malware and the like. During this process, security gateways 410A and 410B typically apply policies that define criteria (e.g., header information, patterns, anomaly information) to be compared with the packet flows and take actions specified by the policies, such as dropping packet flows, logging packet flows or redirecting packet flows to packet analyzers for further analysis. Security gateways 410A and 410B may include, for example, firewalls or other IDP systems, or even high-end routers or service nodes configured to apply network security services to packet flows within public network 480.

In general, security management system 450 provides a central, cloud-based system for managing gateways 410 distributed throughout a set (e.g., fleet) of automobiles 402A and 402B, including installing, editing and removing zone-based policies, automatically updating virus definitions, alerting as to identified threats, and the like. Security management system 450 can receive records of network traffic from security gateways 410A and 410B and perform threat analysis on the records to create updated rules and policies. Additional example details of features provided by security management system 450 and security features that may be incorporated in security gateways 410A and 410B can be found in commonly assigned U.S. Pat. No. 10,135,841, which issued on Nov. 20, 2018, and is entitled “Integrated Security System Having Threat Visualization and Automated Security Device Control,” and in commonly assigned U.S. Patent Application Publication No. 2017/0126727, which was filed on Dec. 30, 2015, and is entitled “Integrated Security System Having Threat Visualization,” which are incorporated herein by reference in their entirety.

Public network 480 may include, for example, one or more client computing devices. Public network 480 may provide access to web servers, application servers, public databases, media servers, end-user devices, and other types of network resource devices and content. Network devices in public network 480 may present a number of security threats to security gateways 410A and 410B and, in particular, internal electronic components of automobiles 402A and 402B protected by the security gateways. For example, devices in public network 480 may attempt to deliver worms, trojans, and/or viruses to one or more of security gateways 410A and 410B. As another example, a hacker using a device in public network 480 may attempt to infiltrate security gateway 410A or 410B to snoop, corrupt, destroy, or steal information stored by one or more components of an automotive system or to gain control of automobile 402A or 402B.

As described herein, security management system 450 enables centralized management of security gateways 410A and 410B by collecting and aggregating threat information from the security gateways 410A and 410B and presenting a unified, real-time visualization of network threats. Moreover, security management system 450 provides an integrated system that provides network administrators, e.g., administrator 452, with a centralized, single point of control for managing security gateways 410A and 410B in response to network threats. Security management system 450 may include a centralized, back-end, policy-controlled, distribution platform. Security management system 450 provides a centralized way to quickly control, manage, and deploy security gateways into automobiles. From security management system 450, administrator 452 can manage and deploy updates to a fleet of millions of automobiles.

For example, security management system 450 receives and aggregates data from security gateways 410A and 410B in real-time as threats are detected and identified. Security gateways 410A and 410B may have a standardized or generic application programming interface for communicating with security management system 450. Security management system 450 renders and maintains an animated representation of the identified threats based on the data aggregated from distributed security gateways 410A and 410B. Responsive to interaction from administrator 452, security management system 450 identifies a relevant set of security gateways 410A and 410B, automatically constructs security policies having ordered rules within the policies for the identified set of security gateways 410A and 410B, and automatically communicates and installs the policies in the identified set of security gateways 410A and 410B using an underlying policy deployment engine integrated within security management system 450.

In this way, security management system 450 enables administrator 452 to take direct actions, such as selectively blocking or allowing traffic and applications, while monitoring events from a representation of threats identified anywhere within public network 480. As such, the administrator is able to interact with the representation of the threats as rendered by security management system 450 to automatically configure and update security policies of security gateways 410A and 410B deployed throughout public network 480.

In common practice, security management system 450 and security gateways 410A and 410B managed by security management system 450 may be centrally maintained by an IT group of the automotive manufacturer. Administrator 452 may interact with security management system 450 to remotely monitor and configure security gateways 410A and 410B. For example, administrator 452 may receive alerts from security management system 450 regarding security gateways 410A and 410B, view live threat and configuration information data of security gateways 410A and 410B, drill-down to filtered representations of filtered threat data, create or update security policies for security gateways 410A and 410B.

Administrator 452 may use security management system 450 to configure security gateways 410A and 410B with security policies, where each security policy represents a set of one or more ordered rules that specify certain operational characteristics that further the objectives of administrator 452. For example, administrator 452 may, using policies with a collection of an ordered set of rules, specify for security gateway 410A or 410B a particular security policy regarding security of incoming or outgoing Internet Protocol (IP) traffic. While described with respect to policies and rules, the techniques of this disclosure may be applicable to other aspects of security devices, including modifying routing tables, or other aspects involving updating or reordering pre-existing security policies or rules.

In general, security gateways 410A and 410B maintain data for a particular policy (e.g., security) as an ordered list of one or more rules that are each keyed to a unique identifier. Upon occurrence of a triggering event in one of the managed security gateways 410A and 410B, such as the receipt of a network packet, the security gateway 410A or 410B sequentially traverses the ordered list to determine the first policy rule in the list that applies to the triggering event data. If the security device finds an applicable policy rule, the security device proceeds to execute the specified action (e.g., drop the packet, update a traffic log, redirect the packet for further analysis and inspection, or block or allow the packet).

Further example details policy management via a centralized network management system capable of managing security devices and deploying policies thereto can be found in commonly assigned U.S. Pat. No. 8,429,255, which issued on Apr. 23, 2013, and is entitled “Determining Reorder Commands for Remote Reordering of Policy Rules,” and in commonly assigned U.S. Pat. No. 8,248,958, which issued on Aug. 21, 2012, and is entitled “Remote Validation of Network Device Configuration Using a Device Management Protocol for Remote Packet,” which are incorporated herein by reference in their entirety. Further examples are described in, Network and Security Manager (NSM) application as described in Juniper Networks, “Juniper Networks Network and Security Manager Administration Guide Revision 2009.1,” August 2009, available at http://www.juniper.net/techpubs/software/management/security-manager/nsm2009_1/nsm-admin-guide.pdf, which is incorporated herein by reference in its entirety.

Security management system 450 can provide a system and interface that administrator 452 utilizes to view live or near-live threats, quickly assess a filtered representation of filtered threat data associated with a given threat for comprehensive analysis, and to configure or modify various security policies of security gateways 410A and 410B in response to the threat. For example, a threat control module of security management system 450 can construct and output an interface to enable administrator 452 to view live threats on, for instance, a grid, chart or map, to drill-down to various filtered representations of filtered threat data associated with the threats, to insert or configure new rules in a current or new policy for one or more of security gateways 410A and 410B, to produce an updated policy for the security gateways 410A and 410B, and to delete or change the ordering of existing rules. In response to producing the new or updated policy, administrator 452 may direct security management system 450 to deploy the configuration to one or more of security gateways 410A and 410B through a policy deployment engine based on the new or updated policy. In some aspects, security management system 450 automatically modifies policies of security gateways 410A and 410B as a response to, for example, the detection of threats.

Security management system 450 integrates threat aggregation and visualization with an underlying device management system capable of centrally managing configuration information for network devices of public network 480, including security gateways 410A and 410B. For example, various implementations and features of security management system 450 as described herein enables administrator 452 to view live network traffic information and quickly diagnose and prevent an attack, such as by seamlessly enabling administrator 452 to quickly block or temporarily block network traffic for a given set of users, applications, geographic regions, combinations thereof, etc. Security management system 450 may further enable administrator 452 to allow network traffic that is not a threat, but may otherwise have been blocked by conventional techniques. As such, security management system 450 enables administrator(s) 452 to seamlessly update, e.g., construct and deploy, security policies to security gateways 410A and 410B, such as to block or allow packet flows between particular source and destination addresses, block or allow only traffic from a source address, or block or allow only traffic to a destination IP address.

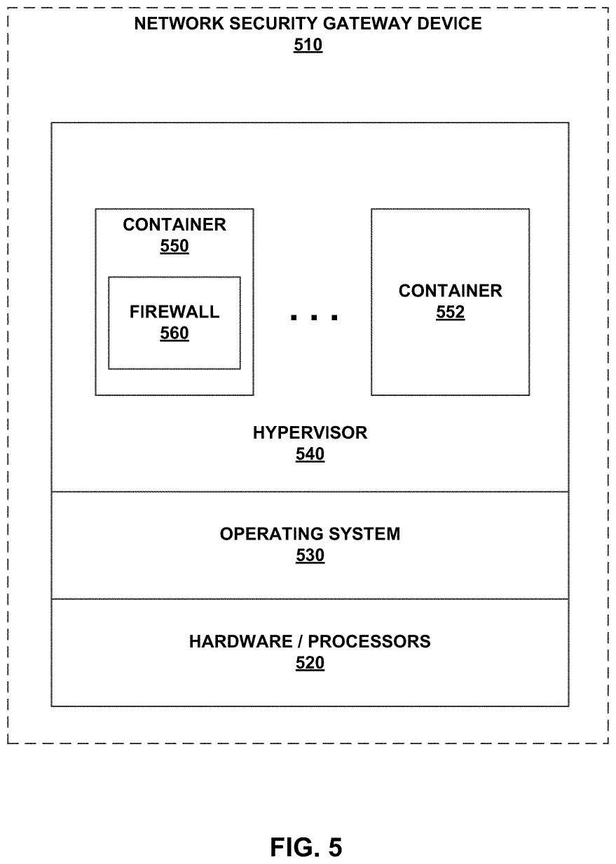

FIG. 5 is a block diagram illustrating one example architecture of a network security gateway device 510 having a firewall 560 executing in a virtual container 550 on a hypervisor 540. Network security gateway device 510 is a containerized implementation of network security gateway device 110 shown in FIG. 1. Hardware processors 520 of network security gateway device 510 represents a hardware platform suitable for executing an embedded, real-time operating system 530 suitable for an automotive environment and can include memory, a power supply, and input-output nodes, such as ethernet ports.

In one example, hardware/processors 520 can include an ARM-based hardware such as the LS1043 line of processors made by NXP Semiconductors N.V. of Eindhoven, Netherlands. Hardware 520 runs operating system 530, which in some examples is the QNX operating system developed by BlackBerry Ltd of Waterloo, Ontario, Canada, which is a real-time operating system for embedded systems applications. Hypervisor 540 runs on operating system 530. An example of hypervisor 540 is the QNX Hypervisor developed by BlackBerry Ltd that provides a Linux environment on top of an operating system such as QNX. Software-based firewall 560 runs on hypervisor 540 as docker container 550. One example of a container-based firewall application is cSRX developed by Juniper Networks, Inc. of Sunnyvale, Calif.

In the example of FIG. 5, hypervisor 540 runs two or more containers 550 and 552. Hypervisor 540 operates on top of operating system 530 and can task-switch and time-slice between containers 550 and 552. Containers 550 and 552 are software processes running on top of hypervisor 540. Containers 550 and 552 are similar to virtual machines but without a full operating system.

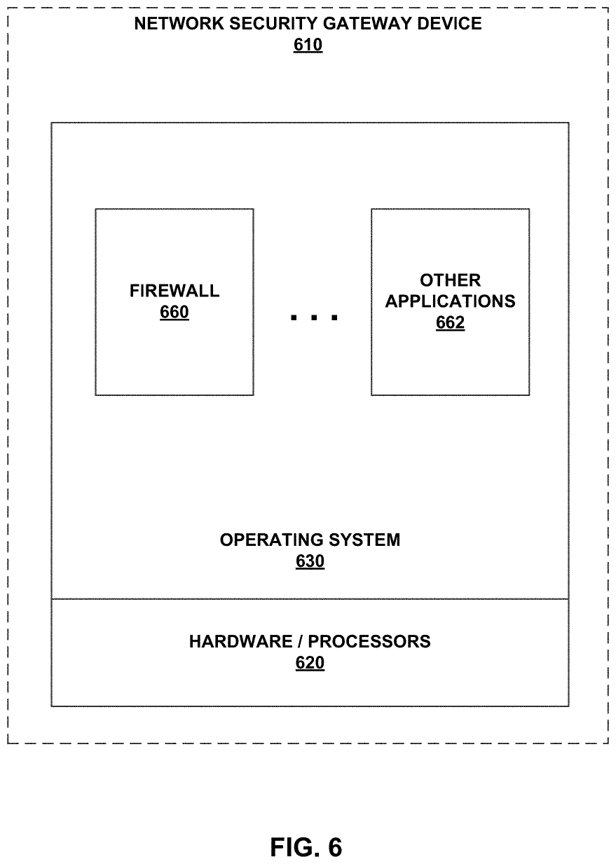

The resources of network security gateway device 510 may be constrained, as compared to a rack-scale networking device. To conserve resources, software-based firewall 560 can be run as an application on a hypervisor or an operating system running directly on the hardware, as shown in FIG. 6.

FIG. 6 is a block diagram illustrating another example architecture for network security gateway device 610 in which firewall 660 executes as a native application on an operating system 630. In this way, network security gateway device 610 is a bare-metal or native implementation of network security gateway device 110 shown in FIG. 1. Although not shown in FIG. 6, network security gateway device 610 can also include memory, a power supply, and input-output nodes, such as ethernet ports.

Software-based firewall 660 runs as an application directly on operating system 630. Other applications 662 can run on operating system 630 simultaneously with firewall 660. Running firewall 660 directly on operating system 630, as compared to running a firewall as a container on a hypervisor, may result in simpler architecture and better performance for firewall 660. However, as a native application, firewall 660 may be coupled to operating system 630 and therefore less portable.

Hardware 520 and 620 may have limited resources, as compared to a rack-scale networking device. To run a robust, feature-rich software-based firewall on hardware 520 and 620, the firewall for a rack-scale networking device may be modified to consume fewer processing resources. For example, a high-end rack-scale networking device may run a next-generation software-based firewall with fifty to one hundred data structures or data representations. To conserve the resources of hardware 520 and 620, firewall 560 and 660 can use as few as one data representation for all types of management and security data structures. Using fewer data representations can greatly reduce the overhead of data management in firewall 560 and 660.

Another technique for reducing the overhead of firewall 560 and 660 is to modify the memory requirements for multiple applications while preserving the functionalities of the applications. To conserve memory, firewall 560 and 660 can shorten the size of the queue to collect login messages. Firewall 560 and 660 can also run a specially designed decoder, sigpack, and accelerator with reduced processing and memory requirements to replace the more expansive decoders, sigpacks, and accelerators that firewalls run on rack-scale networking devices.

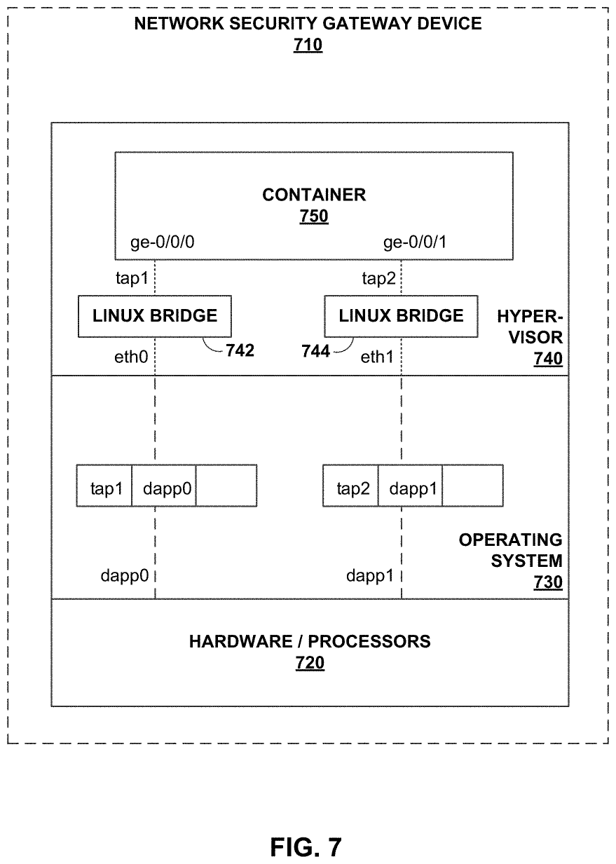

When network security gateway device 510 or 610 receives a packet at the hardware level, the packet is processed through multiple layers according to the architecture of FIGS. 5 and 6. In these examples, these layers include the hardware, operating system, hypervisor, container(s), and application(s) or network security gateway device 510 and 610. In an automotive environment, the various layers may not all be developed or manufactured by the same vendors, which creates mapping and translation issues addressed herein. As shown in the example of FIG. 7, the interfaces and interface names may be configured to map network traffic to pass between the hardware and the software-based firewall.

FIG. 7 is a block diagram illustrating in further detail a network security gateway device 710 running a containerized firewall 750. Network security gateway device 710 is a container-based solution like network security gateway device 510 shown in FIG. 5, although similar techniques may be applied to a virtual machine-based implementation. In this example, container 750 is similar to a Linux docker-based image running on an execution platform. In some examples, hardware 720 does not have sufficient resources to run a rack-scale software-based firewall, so the firewall is modified to run on hardware 720 as described herein.

Network security gateway device 710 receives an inbound packet at hardware 720 and directs the packet to operating system 730, through hypervisor 740, to the correct container 750 and to the correct network interface on container 750. The interfaces of hardware 720, operating system 730, hypervisor 740, and container 750 are matched or stitched together so that the packet is passed up to the correct label or interface on container 750. Network security gateway device 710 includes tunnels or bridges between the layers to allow for the packet to pass between hardware 720 and container 750. The name of an interface on each layer of network security gateway device 710 is mapped to the name of an interface on an adjacent layer of network security gateway device 710.

In this example, operating system 730 has downward facing physical interfaces, labeled dapp0 and dapp1, that map to the physical (e.g., ethernet) ports on hardware 720. Facing upwards are the tap1 and tap2 interfaces exposed by operating system 730. As shown, during processing, a header of a packet includes the tap and dapp information so that network security gateway device 710 can direct the packet to the right interface. Operating system 730 includes virtual network functionality to direct the traffic from the physical interface to an interface of hypervisor 740. In some examples, operating system 730 has another layer for translating bus communications into packet-based data for processing.

In the example shown in FIG. 7, hypervisor 740 is a Linux-based hypervisor, so hypervisor 740 maps each tap to an ethernet interface for Linux bridges 742 and 744. However, in other examples, hypervisor 740 may be based on a non-Linux kernel and may include non-Linux-based bridges. In the example shown in FIG. 7, the tap1 interface is mapped to the eth0 interface, and the tap2 interface is mapped to the eth1 interface. Linux bridge 742 maps the eth0 interface to the tap1 interface, not to be confused with the tap1 interface in operating system 730. Container 750 includes the ge-0/0/0 interface and the ge-0/0/1 interface designators recognized by the firewall services executing within container 750. As one example, the ge-0/0/0 interface and the ge-0/0/1 interface designators may be recognized by Junos-based firewall services executed by container 750, where Junos is an operating system developed by Juniper Networks, Inc. for use on high-end network routers, switches and security appliances. Hypervisor 740 and container 750 can assign the ge-0/0/0 interface of container 750 to the tap1 interface of Linux bridge 742.

For communication from container 750 to a component outside of network security gateway device 710, the software-based firewall maps the ge-0/0/0 interface of the firewall services executing within container 750 to the corresponding tap interface of Linux bridge 742 or 744. Linux bridge 742 or 744 maps the interface of container 750 to the corresponding interface of hypervisor 740. The interface of hypervisor 740 is mapped to the corresponding tap interface of operating system 730. Operating system 730 associates the tap interface with the corresponding dapp interface, which maps to a physical port of hardware 720. In this way, high-end, rich security features of a network-like firewall service may be architected to execute within a container 750 executable in a resource-limited environment provided by network security gateway device 710.

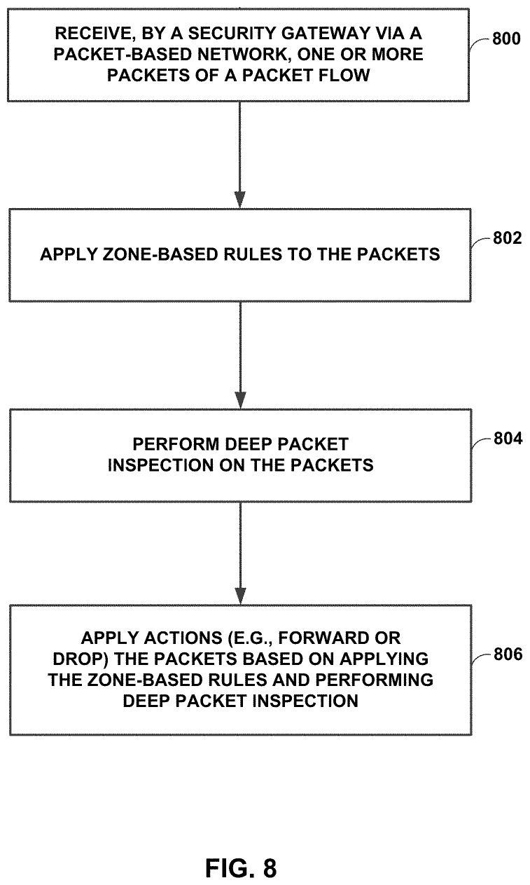

FIG. 8 is a flowchart showing an example operation of a network security gateway device. The example techniques of FIG. 8 are described with reference to network security gateway device 110 shown in FIG. 1, but other components such as security gateways 210, 410A, 410B, 510, 610, and 710 may also perform similar techniques.

In the example of FIG. 8, network security gateway device 110 embedded within an automobile and operating on a resource-limited platform receives a packet via communication network 160 (800). Network security gateway device 110 receives packets from a packet-flow originating at one of non-critical components 120, critical components 140, or public network 180. Network security gateway device 110 can receive the packets at an ethernet port of network security gateway device 110. Alternatively, network security gateway device 110 can receive data at a non-ethernet interface and translate the data to packet form. The non-ethernet interface may be a CAN interface, a LIN interface, or another interface.

In the example of FIG. 8, network security gateway device 110 executes a firewall service that applies zone-based rules to the packet (802). The zone-based rules are based on the source and the destination of the packet. For example, network security gateway device 110 may apply a rule to drop all packets traveling from non-critical components 120 to critical components 140. However, network security gateway device 110 can have specified exceptions to allow packets to travel from a specific non-critical component 120 to a specific critical component 140.

In the example of FIG. 8, network security gateway device 110 performs deep packet inspection on the packet (804). Using deep packet inspection, network security gateway device 110 can block users from accessing specific web addresses, such as video streaming websites, while allowing navigation and mapping services. Network security gateway device 110 can also inspect packets for port scanning, malformed packets, and denial of service attacks.

In the example of FIG. 8, network security gateway device 110 forwards or drops the packet based on applying the zone-based rules and performing deep packet inspection (806). Network security gateway device 110 can store a record of dropped packets to send to security management system 190 at a later time. Network security gateway device 110 and security management system 190 can use the records of dropped packets to identify threats and protect against future attacks. Network security gateway device 110 can also send records of packets dropped and other network traffic statistics and records to security management system 190 for threat analysis. Security management system 190 can perform and use threat analysis to create new policies and rules to prevent intrusions. Security management system 190 sends the new policies and rules as software or firmware updates to network security gateway device 110 via public network 180.

Security gateways 110, 210, 410A, 410B, 510, 610, and 710 can include a general purpose processor, a digital signal processor (DSP), and/or a core processor within an Application Specific Integrated Circuit (ASIC). Security gateways 110, 210, 410A, 410B, 510, 610, and 710 can also include a memory, which is used to store information such as program instructions and other data while the computer is in operation. The memory may be a hard disk drive, nonvolatile memory, or other non-transient storage device stores information such as program instructions, data files of the multidimensional data and the reduced data set, and other information. As another example, security gateways 110, 210, 410A, 410B, 510, 610, and 710 may provide an operating environment for execution of one or more containers or virtual machines that, in turn, provide an execution environment for software for implementing the techniques described herein.

Security gateways 110, 210, 410A, 410B, 510, 610, and 710 include various input-output elements, such as parallel or serial ports, USB, Firewire or IEEE 1394, Ethernet, and other such ports to connect the computer to external device such as a keyboard, touchscreen, mouse, pointer or the like. Other input-output elements include wireless communication interfaces such as Bluetooth, Wi-Fi, and cellular data networks. Security gateways 110, 210, 410A, 410B, 510, 610, and 710 may include fewer than all elements listed above, such as a thin client or mobile device having only some of the shown elements.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer readable data storage medium comprising instructions that, when executed, cause one or more processors to perform one or more of the methods described above. For example, the computer-readable data storage medium or device may store such instructions for execution by a processor. Any combination of one or more computer-readable medium(s) may be utilized.

A computer-readable storage medium (device) may form part of a computer program product, which may include packaging materials. A computer-readable storage medium (device) may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In general, a computer-readable storage medium may be any tangible medium that can contain or store a program for use by or in connection with an instruction execution system, apparatus, or device. Additional examples of computer readable medium include computer-readable storage devices, computer-readable memory, and tangible computer-readable medium. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more DSPs, general purpose microprocessors, ASICs, field-programmable gate arrays (FPGAs), or other equivalent integrated or discrete logic circuitry. Accordingly, the term “processor,” as used herein may refer to any of the foregoing structure or any other processing circuitry suitable for implementation of the techniques described herein. “Processor” may refer to one or more processors, in some examples. In addition, in some aspects, functionality described in this disclosure may be provided within software modules or hardware modules.

Various examples of the invention have been described. These and other examples are within the scope of the following claims.

What is claimed is:

1. An automobile comprising:
a plurality of electrical components interconnected by a communication network;
a set of policies that logically partition the electrical components of the automobile into a first zone having one or more of the critical components and a second zone having one or more of the non-critical components, wherein the policies specify rules for communication between the zones defined for the communication network within the automobile; and
a security gateway embedded within the automobile and coupled, by the communication network, to the one or more critical components and the one or more non-critical components,
wherein the security gateway is configured to provide security operations by applying the policies to communications within the automobile to determine, based on the rules defined by the policies, whether to forward or drop data packets communicated on the communication network.

2. The automobile of claim 1, wherein the security gateway includes intrusion detection and prevention for data packets communicated on the communication network.

3. The automobile of claim 2, wherein the intrusion detection and prevention includes application identification to determine whether to forward or drop the data packets.

4. The automobile of claim 2, wherein the intrusion detection and prevention includes deep packet inspection of data packets communicated on the communication network.

5. The automobile of claim 4, wherein the deep packet inspection includes anti-virus detection to determine whether to forward or drop the data packets.

6. The automobile of claim 4, wherein the deep packet inspection includes pattern recognition to determine whether to forward or drop the data packets.

7. The automobile of claim 1,
wherein the one or more critical components comprise an engine control unit, a body control module, or a driver-assistance system, and
wherein the one or more non-critical components comprise an entertainment system or a Bluetooth module.

8. The automobile of claim 1, wherein the security gateway is configured to apply the rules to each packet at least in part by applying zone-based rules to each packet.

9. The automobile of claim 8, wherein the security gateway is configured to apply zone-based rules by dropping packets traveling from the non-critical components to the critical components.

10. The automobile of claim 8, wherein the security gateway is configured to apply zone-based rules by allowing packets traveling between the non-critical components and a public network.

11. The automobile of claim 1, wherein the security gateway is configured to apply the rules to each packet at least in part by performing deep packet inspection on each packet.

12. The automobile of claim 1, wherein the security gateway is configured to run a software-based firewall on a hypervisor to apply the rules to each packet.

13. The automobile of claim 12,
wherein the hypervisor runs on an operating system running on one or more processors of the security gateway, or
wherein the hypervisor runs directly on one or more processors of the security gateway.

14. The automobile of claim 1,
wherein the security gateway presents a standardized application programming interface to an external security management system, and
wherein the security gateway sends records of the data packets communicated on the communication network to the external security management system for threat analysis.

15. The automobile of claim 14, wherein the security gateway is configured to receive software updates from the external security management system.

16. A method for operating a security gateway in an automobile, the method comprising:
receiving, by the security gateway, a packet via a packet-based network interconnecting one or more critical components and one or more non-critical components of the automotive system;
applying, by the security gateway, rules to the packet; and
dropping, by the security gateway, the packet or forwarding, by the security gateway, the packet to a destination on the packet-based network based on applying the rules to the packet.

17. The method of claim 16, wherein applying the rules to the packet comprises performing intrusion detection and prevention by performing deep packet inspection of the packet.

18. The method of claim 16, further comprising implementing policies to logically partition electrical components of the automotive system into a first zone having the one or more critical components and a second zone having the one or more non-critical components,
wherein the policies specify rules for communication between the first and second zones defined for the communication network within the automotive system
wherein applying the rules to the packet comprises applying zone-based rules to the packet by:
dropping packets traveling from the one or more non-critical components to the one or more critical components; and
allowing packets traveling between the one or more non-critical components and a public network.

19. A device comprising a computer-readable medium having executable instructions stored thereon, configured to be executable by processing circuitry for causing the processing circuitry to:
receive a packet via a packet-based network interconnecting one or more critical components and one or more non-critical components of the automotive system;
apply rules to the packet; and
drop the packet or forward the packet to a destination on the packet-based network based on applying the rules to the packet.

20. The device of claim 19, wherein the instructions to apply the rules to the packet comprise instructions to:
perform intrusion detection and prevention by performing deep packet inspection of the packet; and
perform pattern recognition to determine whether to forward or drop the packet.
